(19) United States
(12) Patent Application Publication
(10) Pub. No.: US 2023/0411754 A1
(43) Pub. Date: Dec. 21, 2023

(54) VARIABLE ARRAY RETENTION STRATEGIES

(71) Applicant: FORD GLOBAL TECHNOLOGIES, LLC, Dearborn, MI (US)

(72) Inventors: Mike Popovski, Warren, MI (US); Ihab Grace, Grosse Pointe Woods, MI (US)

(21) Appl. No.: 17/840,664

(22) Filed: Jun. 15, 2022

(51) Int. Cl. H01M 50/209; H01M 50/271; H01M 50/262

(52) U.S. Cl. CPC H01M 50/209; H01M 50/271; H01M 50/262; H01M 2220/20

(57) ABSTRACT

Exemplary traction battery pack designs are disclosed for use in electrified vehicles. Exemplary traction battery packs may include an outer enclosure assembly establishing an interior, a battery array housed within the interior, a battery internal structure adjacent to the battery array, and a carrier plate assembly arranged to secure the battery array to the battery internal structure. The carrier plate assembly may include a carrier plate and a floating cage nut. The cage nut may accommodate a fastener for securing the battery array to the battery internal structure.

### TECHNICAL FIELD

This disclosure relates generally to electrified vehicle traction battery packs, and more particularly to assemblies for mounting battery internal components to battery internal structures.

### BACKGROUND

A high voltage traction battery pack typically powers an electric machine and other electrical loads of an electrified vehicle. The traction battery pack includes a plurality of battery cells and various other battery internal components that are housed inside an outer enclosure assembly for supporting the electric propulsion of the electrified vehicle. Some traction battery packs incorporate battery arrays of various sizes in order to meet energy capacity requirements.

### SUMMARY

A traction battery pack according to an exemplary aspect of the present disclosure includes, among other things, an outer enclosure assembly providing an interior, a battery internal component housed within the interior, a battery internal structure disposed within the interior at a location adjacent to the battery internal component, and a carrier plate assembly mountable to the battery internal structure and arranged to establish a mounting point for securing the battery internal component to the battery internal structure.

In a further non-limiting embodiment of the foregoing traction battery pack, the outer enclosure assembly includes an enclosure tray that extends along a central longitudinal axis. The battery internal structure extends along a second longitudinal axis that is transverse to the central longitudinal axis.

In a further non-limiting embodiment of either of the foregoing traction battery packs, the battery internal structure is a rigid cross member that connects between a pair of longitudinally extending side walls of an enclosure tray of the outer enclosure assembly.

In a further non-limiting embodiment of any of the foregoing traction battery packs, the battery internal component is a battery array.

In a further non-limiting embodiment of any of the foregoing traction battery packs, the carrier plate assembly includes a carrier plate and a cage nut held within the carrier plate.

In a further non-limiting embodiment of any of the foregoing traction battery packs, the cage nut is a free floating cage nut.

In a further non-limiting embodiment of any of the foregoing traction battery packs, the carrier plate is mounted to a pair of opposing vertical walls of a stanchion of the battery internal structure. The cage nut includes a barrel that is received within a groove that extends between the pair of opposing vertical walls.

In a further non-limiting embodiment of any of the foregoing traction battery packs, the carrier plate is received within a groove formed in a base of the battery internal structure, and the cage nut includes a barrel that is received within a groove that extends outwardly of the groove.

In a further non-limiting embodiment of any of the foregoing traction battery packs, a fastener extends through a support structure of the battery internal component and then into a cage nut of the carrier plate assembly for securing the battery internal component to the battery internal structure.

In a further non-limiting embodiment of any of the foregoing traction battery packs, a carrier plate of the carrier plate assembly is secured to the battery internal structure by a weld.

In a further non-limiting embodiment of any of the foregoing traction battery packs, the carrier plate assembly includes a carrier plate and a plurality of cage nuts held within the carrier plate.

In a further non-limiting embodiment of any of the foregoing traction battery packs, each of the plurality of cage nuts establishes a separate mounting point of the carrier plate assembly.

A traction battery pack according to another exemplary aspect of the present disclosure includes. among other things, an outer enclosure assembly including a tray and a cover, a battery internal structure extending between a pair of longitudinally extending side walls of the tray, a first battery array located on a first side of the battery internal structure, a first carrier plate assembly mounted to the battery internal structure and configured for securing the first battery array to the battery internal structure, a second battery array located on a second side of the battery internal structure, and a second carrier plate assembly mounted to the battery internal structure and configured for securing the second battery array to the battery internal structure. The first battery array includes a first length and the second battery array includes a second length that is different from the first length.

In a further non-limiting embodiment of the foregoing traction battery pack, the battery internal structure is a rigid cross member that extends along an axis that is transverse to a central longitudinal axis of the tray.

In a further non-limiting embodiment of either of the foregoing battery packs, the battery internal structure, a carrier plate of the first carrier plate assembly, and a carrier plate of the second carrier plate assembly are each made of a common type of material.

In a further non-limiting embodiment of any of the foregoing battery packs, the common type of material is aluminum.

In a further non-limiting embodiment of any of the foregoing battery packs, each of the first carrier plate assembly and the second carrier plate assembly includes a carrier plate and a cage nut held within the carrier plate.

In a further non-limiting embodiment of any of the foregoing battery packs, the carrier plate is mounted to a stanchion or a base of the battery internal structure. The cage nut includes a barrel that is received within a groove established by the stanchion or the base.

In a further non-limiting embodiment of any of the foregoing battery packs, a fastener extends through a support structure of the first battery array or the second battery array and then into the cage nut for securing the first battery array or the second battery array to the battery internal structure.

In a further non-limiting embodiment of any of the foregoing battery packs, at least one of the first carrier plate assembly or the second carrier plate assembly includes a carrier plate and a plurality of cage nuts held within the carrier plate.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a traction battery pack of an electrified vehicle.

FIG. 3 is a perspective view of the traction battery pack of FIG. 2 with select portions removed in order to better illustrate an interior of the traction battery pack.

FIG. 4 illustrates a battery internal structure of the traction battery pack of FIG. 3.

FIG. 5 is a cross-sectional view through section 5-5 of FIG. 4.

FIG. 6 illustrates a battery array secured to a battery internal structure by a carrier plate assembly.

FIG. 7 illustrates another exemplary carrier plate assembly of a traction battery pack.

FIG. 8 illustrates another exemplary battery internal structure and carrier plate assembly for use within a traction battery pack.

### DETAILED DESCRIPTION

This disclosure details exemplary traction battery pack designs for use in electrified vehicles. Exemplary traction battery packs may include an outer enclosure assembly establishing an interior, a battery array housed within the interior, a battery internal structure adjacent to the battery array, and a carrier plate assembly arranged to secure the battery array to the battery internal structure. The carrier plate assembly may include a carrier plate and a floating cage nut. The cage nut may accommodate a fastener for securing the battery array to the battery internal structure. These and other features are discussed in greater detail in the following paragraphs of this detailed description.

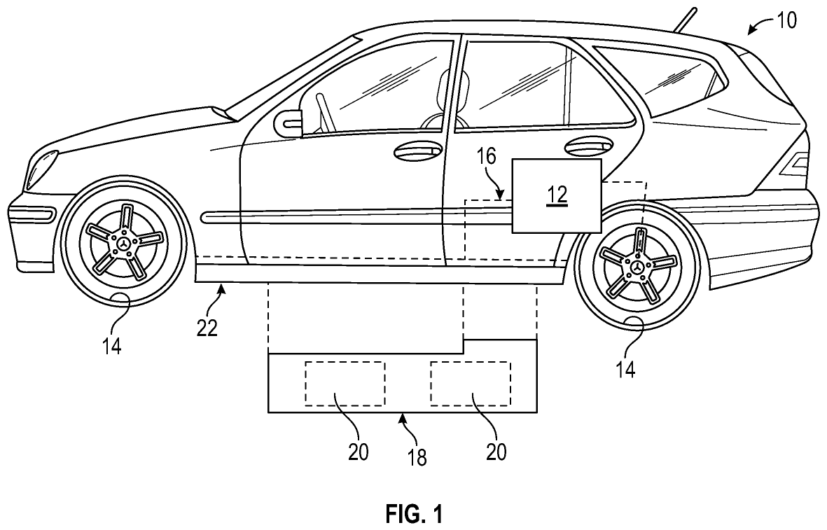

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the electrified vehicle 10 could be equipped with an internal combustion engine that can be employed either alone or in combination with other power sources to propel the electrified vehicle 10.

In the illustrated embodiment, the electrified vehicle 10 is a sport utility vehicle (SUV). However, the electrified vehicle 10 could alternatively be a car, a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10

A voltage bus 16 may electrically couple the electric machine 12 to a traction battery pack 18. The traction battery pack 18 is an exemplary electrified vehicle battery. The traction battery pack 18 may be a high voltage traction battery pack that includes one or more battery arrays 20 (i.e., battery assemblies or groupings of rechargeable battery cells) capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 22 of the electrified vehicle 10. However, the traction battery pack 18 could be located elsewhere on the electrified vehicle 10 within the scope of this disclosure.

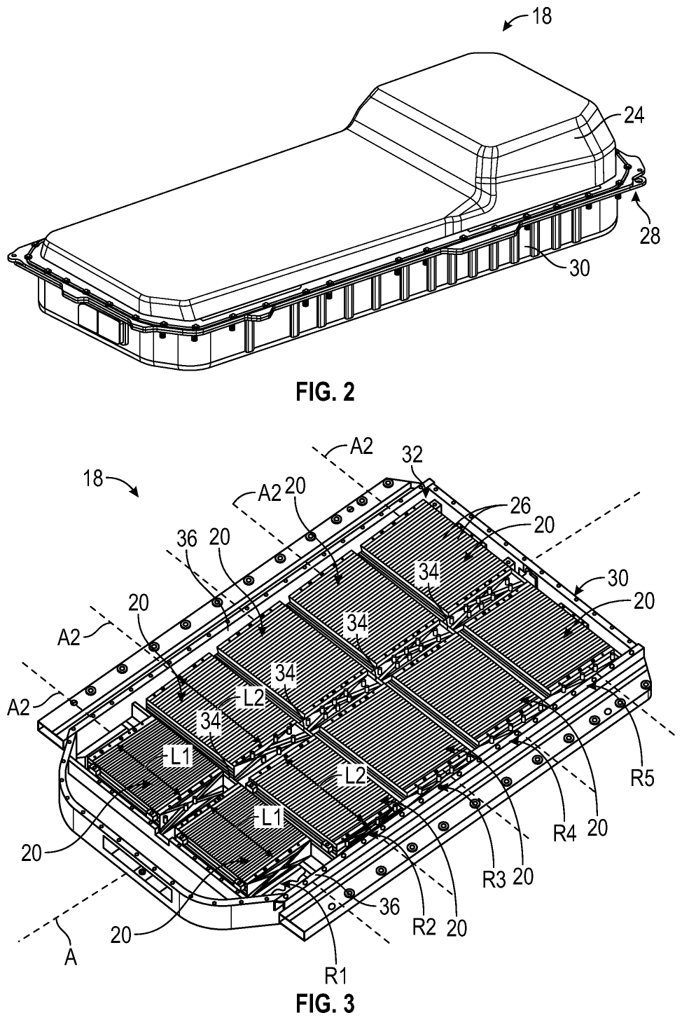

FIGS. 2 and 3 illustrate a traction battery pack 18 that can be employed within an electrified vehicle, such as the electrified vehicle 10 of FIG. 1. FIG. 2 is an assembled, perspective view of the traction battery pack 18, and portions (e.g., an enclosure cover 24) of the traction battery pack 18 are removed in FIG. 3 in order to better visualize its internal contents.

The traction battery pack 18 may house a plurality of battery cells 26 that store energy for powering various electrical loads of the electrified vehicle 10. The traction battery pack 18 could employ any number of battery cells 26 within the scope of this disclosure. Accordingly, this disclosure is not limited to the exact configuration shown in FIGS. 2-3.

The battery cells 26 may be stacked side-by-side along one or more stack axes to construct groupings of battery cells 26, sometimes referred to as “cell stacks” or “cell arrays.” In an embodiment, the battery cells 26 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery cells 26 of each grouping, along with any support structures (e.g., array frames, spacers, rails, walls, plates, bindings, etc.), may collectively be referred to as a battery assembly or a battery array 20. The traction battery pack 18 depicted in FIG. 3 includes five rows (labeled as rows R1, R2, R3, R4, and R5) of two laterally adjacent battery arrays 20 for a total of ten battery arrays 20. However, the traction battery pack 18 could include a greater or fewer number of battery arrays and still fall within the scope of this disclosure.

An outer enclosure assembly 28 may house each battery array 20 of the traction battery pack 18. The outer enclosure assembly 28 may be a sealed enclosure and may embody any size, shape, and configuration within the scope of this disclosure. In an embodiment, the outer enclosure assembly 28 includes the enclosure cover 24 and an enclosure tray 30. Together, the enclosure cover 24 and the enclosure tray 30 may establish an interior 32 for housing the battery arrays 20 and other battery internal components (e.g., bussed electrical center, battery electric control module, wiring, connectors, etc.) of the traction battery pack 18.

A battery internal structure 34, such as a relatively rigid cross member, may be positioned between each adjacent row of battery arrays 20. In general, the battery internal structures 34 are arranged to add rigidity to the traction battery pack 18 and, as further discussed below, establish mounting points for securing the battery arrays 20 and/or other battery internal components relative to the enclosure tray 30.

In an embodiment, one battery internal structure 34 is disposed between the rows R1 and R2 of battery arrays 20, another battery internal structure 34 is disposed between the rows R2 and R3, another battery internal structure 34 is disposed between the rows R3 and R4, and yet another battery internal structure 34 is disposed between the rows R4 and R5 for a total of four battery internal structures 34 provided within the enclosure tray 30. However, the total number of battery internal structures 34 provided within the interior 32 established by the outer enclosure assembly 28 is not intended to limit this disclosure.

The battery internal structures 34 may connect between longitudinally extending side walls 36 of the enclosure tray 30 and therefore are arranged, in the illustrated embodiment, in a cross-vehicle orientation. In an embodiment, both the battery arrays 20 and the battery internal structures 34 extend along axes A2 (see FIG. 3) that are generally perpendicular to a central longitudinal axis A1 of the enclosure tray 30. However, other arrangements are also contemplated.

The traction battery pack 18 may include battery arrays 20 of at least two different sizes. For example, in the illustrated embodiment, the battery arrays 20 of the first row R1 include a first length L1 that is shorter than a second length L2 of the battery arrays 20 of each of rows R2, R3, R4, and R5. The actual dimensions of the first length L1 and the second length L2 are not intended to limit this disclosure and could vary depending on the design requirements of the traction battery pack 18. Having different sized battery arrays 20 within the traction battery pack 18 can increase assembly complexities by necessitating the need for battery internal structures 34 that include multiple different mounting configurations (e.g., various tapped mounting hole locations, unique bracket designs, etc.). This disclosure is therefore directed to assemblies that provide an adjustable solution for mounting battery arrays and/or other battery internal components of varying sizes relative to a common battery internal structure design.

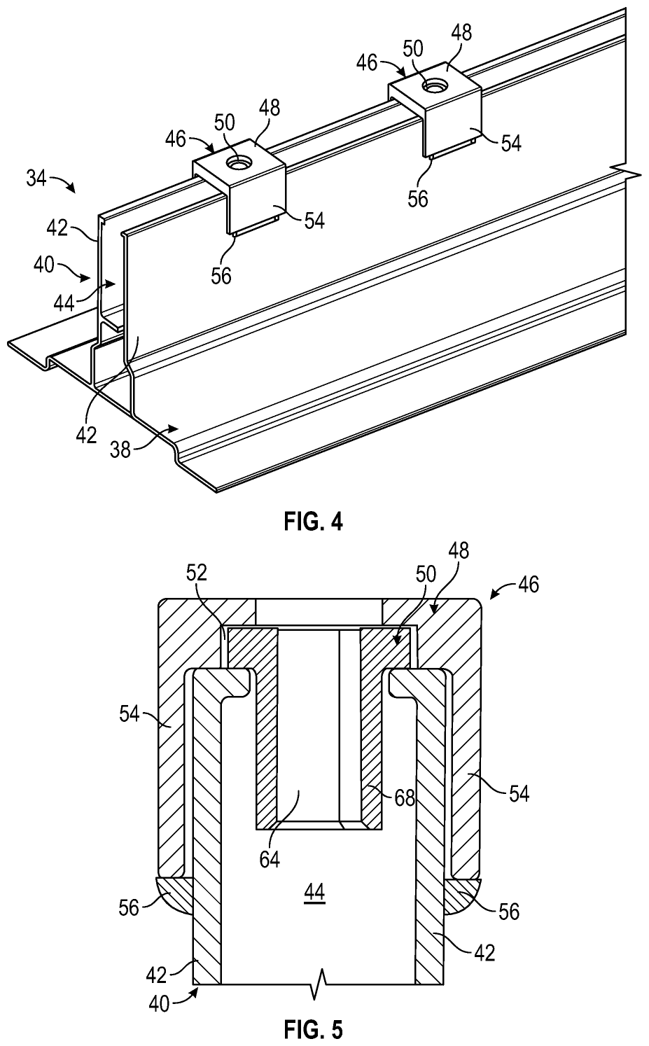

Referring now to FIGS. 4, 5, and 6, with continued reference to FIGS. 1-3, each battery internal structure 34 may include a base 38 and a stanchion 40 that protrudes upwardly from the base 38. Together, the base 38 and the stanchion 40 may establish a unitary, single-piece design of the battery internal structure 34. The stanchion 40 may include a pair of opposing vertical walls 42. The vertical walls 42 may be separated by a groove 44. The groove 44 may extend across an entire length of the battery internal structure 34.

The battery internal structure 34 may be a metallic component. In an embodiment, the battery internal structure 34 is constructed out of aluminum. However, other materials are also contemplated within the scope of this disclosure.

One or more carrier plate assemblies 46 may be mounted to each battery internal structure 34 of the traction battery pack 18. The carrier plate assemblies 46 may establish mounting points for securing the battery arrays 20 (and/or other battery internal components) directly to the battery internal structure 34. The mounting points provided by the carrier plate assemblies 46 may be provided without the need to tap holes in the battery internal structure 34, for example.

Each carrier plate assembly 46 may include a carrier plate 48 and a cage nut 50 housed within the carrier plate 48. The cage nut 50 may be received within a slot 52 of the carrier plate 48. The slot 52 may be sized and shaped to retain the cage nut 50 while allowing for some axial movement of the cage nut 50 relative to the carrier plate 48. The cage nut 50 may thus exhibit a floating design for accepting larger positional tolerances when mounting the battery arrays 20 relative to the battery internal structure 34. In an embodiment, the cage nut 50 is configured to receive a fastener from either side.

The carrier plate 48 and the cage nut 50 may be made of different metallic materials. In an embodiment, the carrier plate 48 is constructed out of aluminum, and the cage nut 50 is constructed out of steel. However, other materials may also be suitable. In another embodiment, the carrier plate 48 and the battery internal structure 34 are made out of the same material (e.g., aluminum).

The carrier plate assembly 46 may be positioned relative to the battery internal structure 34 such that the cage nut 50 is accommodated with the groove 44 and mounting flanges 54 of the carrier plate 48 interface with the vertical walls 42 of the stanchion 40. The carrier plate assembly 46 may be slid or otherwise moved along a length of the battery internal structure 34 until a desired position is reached. The mounting flanges 54 of the carrier plate 48 may then be fixedly secured to the vertical walls 42, such as by welds 56, for example.

The ability to adjust the position of the carrier plate assembly 46 prior to its permanent fixation to the battery internal structure 34 allows for a common battery internal structure design to be used across all traction battery pack models and may further allow for the use of a common retention strategy, thereby reducing assembly complexities. Further, the use of a common material for both the carrier plate 48 and the battery internal structure 34 facilitates increased weldability of these two adjoining structures.

The cage nut 50 may include a barrel 68 that includes an opening 64 extending therethrough. The opening 64 may be sized to receive a fastener. In an embodiment, the barrel 68 extends in a direction toward the enclosure tray 30 when the cage nut 50 is received within the slot 52 of the carrier plate 48.

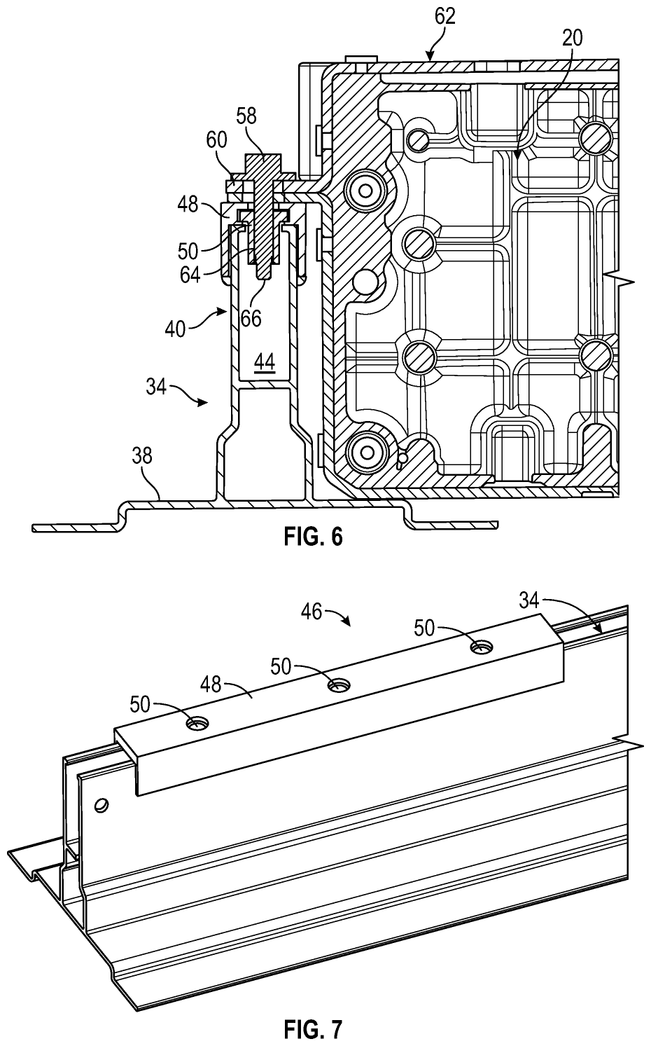

A fastener 58 (see FIG. 6), such as a screw or a column bolt, may be utilized to fixedly secure a battery array 20 to the battery internal structure 34. The fastener 58 may be inserted through a fastener housing or flange 60 of an array support structure 62 (e.g., top plate, bottom plate, end plate, side plate, array frame, etc.) of the battery array 20 and then into the opening 64 of the cage nut 50. At least a portion of a shaft 66 of the fastener 58 may be accommodated within the groove 44 of the stanchion 40 of the battery internal structure 34.

The exemplary carrier plate assemblies 46 shown in FIGS. 4, 5, and 6 each include a single cage nut 50. However, in other implementations, the carrier plate 48 could be configured to include multiple cage nuts 50 (see, e.g., FIG. 7).

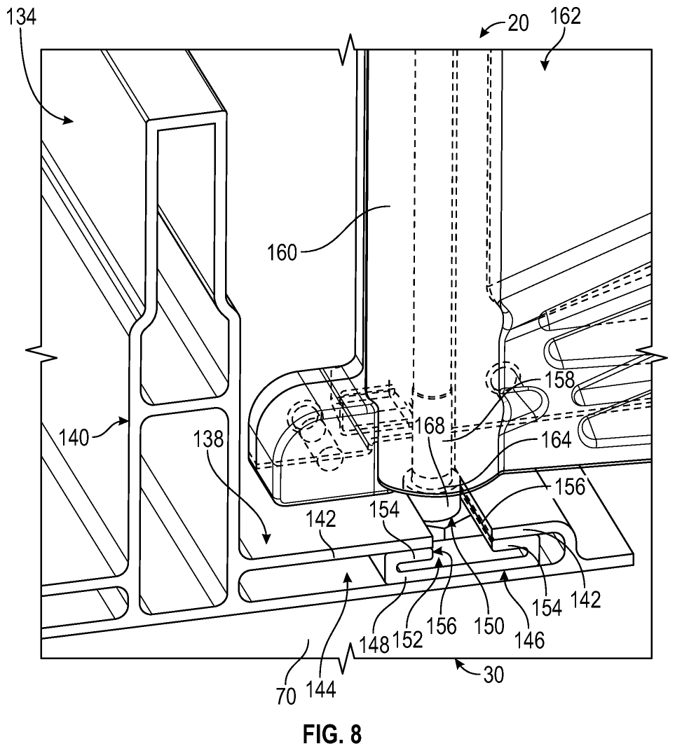

In the embodiments described above, the battery arrays 20 are secured to the top portion of the battery internal structure 34. However, other designs are also contemplated. FIG. 8, for example, illustrates a mounting configuration in which a battery array 20 is secured to a bottom portion of a battery internal structure 134.

The battery internal structure 134 of FIG. 8 may include a base 138 and a stanchion 140 that protrudes upwardly from the base 138. The base 138 may be received against a floor 70 of the enclosure tray 30. The base 138 may include one or more grooves 144 that are sized for accommodating a carrier plate assembly 146. The carrier plate assembly 146 may be slidably received within the groove 144 to establish one or more mounting points for securing the battery array 20 to the battery internal structure 134.

The carrier plate assembly 146 may include a carrier plate 148 and a cage nut 150 housed within the carrier plate 148. The cage nut 150 may be received within a slot 152 of the carrier plate 148. The slot 152 may be sized and shaped to retain the cage nut 150 while allowing for some axial movement of the cage nut 150 relative to the carrier plate 148. The cage nut 150 may thus exhibit a floating design for accepting larger positional tolerances when mounting the battery array 20 relative to the battery internal structure 134.

The carrier plate 148 and the cage nut 150 may be made of different metallic materials. In an embodiment, the carrier plate 148 is constructed of aluminum and the cage nut 150 is constructed of steel. However, other materials may also be suitable. In another embodiment, the carrier plate 148 and the battery internal structure 134 are made out of the same material (e.g., aluminum).

The carrier plate assembly 146 may be positioned relative to the battery internal structure 134 such that the cage nut 150 is accommodated within the groove 144 and mounting flanges 154 of the carrier plate 148 interface with walls 142 of the base 138. The carrier plate assembly 146 may be slid or otherwise moved along a length of the battery internal structure 134 until a desired mounting position is reached. The mounting flanges 154 of the carrier plate 148 may then be fixedly secured to the walls 142, such as by welds 156, for example.

The ability to adjust the position of the carrier plate assembly 146 prior to its permanent fixation to the battery internal structure 134 allows for a common battery internal structure design to be used across all traction battery pack models and may further allow for the use of a common retention strategy, thereby reducing assembly complexities. Further, the use of a common material for the carrier plate 148 and the battery internal structure 134 facilitates weldability of the two adjoining structures.

The cage nut 150 may include a barrel 168 that defines an opening 164 for receiving a fastener. In an embodiment, the barrel 168 extends in a direction away from the floor 70 of the enclosure tray 30 (e.g., toward the enclosure cover) when the cage nut 150 is received within the slot 152 of the carrier plate 148.

A fastener 158, such as a screw or a column bolt, may be utilized to fixedly secure a battery array 20 to the battery internal structure 134. The fastener 158 may be inserted through a fastener housing 160 of an array support structure 162 (e.g., end plate, side plate, array frame, etc.) of the battery array 20 and then into the opening 164 of the cage nut 150 to mount the battery array 20 to the battery internal structure 134.

The exemplary traction battery packs of this disclosure incorporate carrier plate assemblies that provide an adjustable structure for mounting multiple battery array sizes. The assemblies allow for a common retention strategy and a common battery internal structure design to be used across all traction battery pack models. The proposed assemblies further reduce assembly complexities by allowing fasteners to be secured using either a top or a bottom mounting configuration.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an outer enclosure assembly providing an interior;
a battery internal component housed within the interior;
a battery internal structure disposed within the interior at a location adjacent to the battery internal component; and
a carrier plate assembly mountable to the battery internal structure and arranged to establish a mounting point for securing the battery internal component to the battery internal structure.

2. The traction battery pack as recited in claim 1, wherein the outer enclosure assembly includes an enclosure tray that extends along a central longitudinal axis, and further wherein the battery internal structure extends along a second longitudinal axis that is transverse to the central longitudinal axis.

3. The traction battery pack as recited in claim 1, wherein the battery internal structure is a rigid cross member that connects between a pair of longitudinally extending side walls of an enclosure tray of the outer enclosure assembly.

4. The traction battery pack as recited in claim 1, wherein the battery internal component is a battery array.

5. The traction battery pack as recited in claim 1, wherein the carrier plate assembly includes a carrier plate and a cage nut held within the carrier plate.

6. The traction battery pack as recited in claim 5, wherein the cage nut is a free floating cage nut.

7. The traction battery pack as recited in claim 5, wherein the carrier plate is mounted to a pair of opposing vertical walls of a stanchion of the battery internal structure, and further wherein the cage nut includes a barrel that is received within a groove that extends between the pair of opposing vertical walls.

8. The traction battery pack as recited in claim 5, wherein the carrier plate is received within a groove formed in a base of the battery internal structure, and further wherein the cage nut includes a barrel that is received within a slot that extends outwardly of the groove.

9. The traction battery pack as recited in claim 1, comprising a fastener that extends through a support structure of the battery internal component and then into a cage nut of the carrier plate assembly for securing the battery internal component to the battery internal structure.

10. The traction battery pack as recited in claim 1, wherein a carrier plate of the carrier plate assembly is secured to the battery internal structure by a weld.

11. The traction battery pack as recited in claim 1, wherein the carrier plate assembly includes a carrier plate and a plurality of cage nuts held within the carrier plate.

12. The traction battery pack as recited in claim 11, wherein each of the plurality of cage nuts establishes a separate mounting point of the carrier plate assembly.

13. A traction battery pack, comprising:
an outer enclosure assembly including a tray and a cover;
a battery internal structure extending between a pair of longitudinally extending side walls of the tray;
a first battery array located on a first side of the battery internal structure;
a first carrier plate assembly mounted to the battery internal structure and configured for securing the first battery array to the battery internal structure;
a second battery array located on a second side of the battery internal structure; and
a second carrier plate assembly mounted to the battery internal structure and configured for securing the second battery array to the battery internal structure,
wherein the first battery array includes a first length and the second battery array includes a second length that is different from the first length.

14. The traction battery pack as recited in claim 13, wherein the battery internal structure is a rigid cross member that extends along an axis that is transverse to a central longitudinal axis of the tray.

15. The battery pack as recited in claim 13, wherein the battery internal structure, a carrier plate of the first carrier plate assembly, and a carrier plate of the second carrier plate assembly are each comprised of a common type of material.

16. The battery pack as recited in claim 15, wherein the common type of material is aluminum.

17. The battery pack as recited in claim 13, wherein each of the first carrier plate assembly and the second carrier plate assembly includes a carrier plate and a cage nut held within the carrier plate.

18. The battery pack as recited in claim 17, wherein the carrier plate is mounted to a stanchion or a base of the battery internal structure, and further wherein the cage nut includes a barrel that is received within a groove established by the stanchion or the base.

19. The battery pack as recited in claim 18, comprising a fastener that extends through a support structure of the first battery array or the second battery array and then into the cage nut for securing the first battery array or the second battery array to the battery internal structure.

20. The battery pack as recited in claim 13, wherein at least one of the first carrier plate assembly or the second carrier plate assembly includes a carrier plate and a plurality of cage nuts held within the carrier plate.
